(19) United States
(12) Patent Application Publication
(10) Pub. No.: US 2002/0072376 A1
(43) Pub. Date: Jun. 13, 2002

(54) Systems and methods for improving positioning in a communications network

(76) Inventors: Hans Carlsson, Cary, NC (US); John Diachina, Garner, NC (US); Christofer Flinta, Stockholm (SE)

Correspondence Address: HARRITY & SNYDER, LLP, 11240 WAPLES MILL ROAD, SUITE 300, FAIRFAX, VA, 22030, US

(21) Appl. No.: 09/731,975

(22) Filed: Dec. 8, 2000

(51) Int. Cl. H04Q 7/20

(52) U.S. Cl. 455/456; 455/457; 455/458; 455/418

(57) ABSTRACT

A system determines a position of a mobile terminal tuned to a first control channel. The system sends a paging request to the mobile terminal via the first control channel. The paging request indicates that the mobile terminal is to switch to a second control channel. The system also receives a paging response from the mobile terminal via the second control channel and determines the position of the mobile terminal based on the paging response.

### BACKGROUND OF THE INVENTION

The present invention relates generally to networks and, more particularly, to systems and methods for determining the positioning of a mobile terminal in a wireless communication network.

Today's mobile communications users desire increasingly fast, more robust and more efficient wireless communication systems. Accordingly, manufacturers and standards bodies are continually improving current systems and implementing new standards to support additional capabilities. One such standard for providing data over both Global System for Mobile communications (GSM) and Time Division Multiple Access (TDMA)/136 systems is the Enhanced General Packet Radio Service (EGPRS).

An EGPRS-136 system integrates the TIA/EIA-136 circuit-switched air interface with the General Packet Radio Service (GPRS) as specified in GSM. More specifically, EGPRS-136 supports circuit-switched services on a 30 kHz air-interface as specified in TIA/EIA-136 and TIA/EIA-41 (ANSI-41) and packet data service on a 200 kHz air interface as specified in GSM. Thus, an EGPRS-136 mobile terminal may send and receive voice calls, as well as, send and receive e-mails, surf the web, etc.

One area of wireless communications that has seen a lot of attention in recent years is the area of mobile terminal positioning. In current TIA/EIA-136/ANSI-41 systems and GSM systems, the network's mobile switching center (MSC)/visitor location register (VLR) determines a mobile terminal's position within the network. For example, if the MSC/VLR receives a positioning request for a mobile terminal while the mobile terminal is involved in an active telephone call on a circuit-switched channel, the MSC/VLR already knows in which cell the mobile terminal is located. In this case, the cell of interest is the cell in which the network sends and receives speech data to/from the mobile terminal. If the MSC/VLR receives a positioning request for a mobile terminal that is tuned to a circuit-switched control channel, the MSC/VLR may send the mobile terminal a page via the circuit-switched channel. When a page response is received from the mobile terminal, the MSC/VLR may determine in which cell the mobile terminal is located. The MSC/VLR may make this determination based on the cell in which the page response was received.

Another current positioning solution is System Assisted Mobile Positioning through Satellite (SAMPS). SAMPS is a positioning solution for TDMA/ANSI-41 that utilizes the existing Global Positioning System (GPS) infrastructure. A SAMPS-capable mobile terminal is equipped with a GPS receiver to support the positioning procedures. The SAMPS service also utilizes the data capabilities of TIA/EIA-136 networks to enhance the performance of GPS-equipped mobile terminals by providing “assistance.”

For example, a SAMPS-capable mobile terminal may be provided with the following pieces of assistance data by the SAMPS service: Almanac, Ephemeris and Clock Corrections, Ionospheric Corrections, Reference Time, and Reference Location information. The Almanac provides a long term model for the orbital parameters of the satellites and is useful in determining a coarse position of the satellites at a given reference location at a certain reference time.

The Ephemeris and Clock Corrections allow accurate computation of the positions of the GPS satellites at the time of the measurements. Mobile terminals may use the Ionospheric Corrections to compensate for ionospheric delays through the atmosphere.

Reference Location provides a typically crude estimate, to within approximately 50-100 km (in some cases it may be more accurate), of the mobile terminal's current position. Reference Location may be obtained either from the network (e.g., from control channels) or from previous recent position fixes using the GPS receiver.

Reference Time provides an estimate of the current GPS time. Reference Time may be obtained, for example, from a digital control channel (DCCH) by sending a relationship between the GPS time and time on the DCCH for some epoch of the GPS time. When the mobile terminal is camping on the DCCH, the DCCH time is available at any instance. The mobile terminal may compute the GPS time at a given instance by adding the difference between the current epoch and the epoch for which the GPS time to DCCH time relationship was provided to the GPS time.

### BRIEF SUMMARY OF THE INVENTION

Systems and methods, consistent with the present invention, determine the position of mobile terminals camped on packet control channels.

In accordance with the invention as embodied and broadly described herein, a method for determining a position of a mobile terminal tuned to a first control channel is provided. The method includes transmitting a paging request to the mobile terminal via the first control channel; switching from the first control channel to a second control channel; transmitting a paging response via the second control channel; and determining the position of the mobile terminal based on the paging response.

In another implementation consistent with the present invention, a system for determining a position of a mobile terminal tuned to a first control channel in a wireless communication network includes a memory and a processor. The processor sends a paging request to the mobile terminal via the first control channel, the paging request indicating that the mobile terminal is to switch to a second control channel, receives a paging response from the mobile terminal via the second control channel, transmits a position request to the mobile terminal, receives a position response, and determines the position of the mobile terminal based on the position response.

### BRIEF DESCRIPTION OF THE DRAWINGS

The accompanying drawings, which are incorporated in and constitute a part of this specification, illustrate the invention and, together with the description, explain the invention. In the drawings,

FIG. 1 illustrates an exemplary network in which systems and methods, consistent with the present invention, may be implemented;

FIG. 2 illustrates an exemplary configuration of a mobile terminal consistent with the present invention;

FIG. 3 illustrates an exemplary configuration of a gateway/serving (G/S) MSC/VLR consistent with the present invention;

FIG. 4 illustrates an exemplary process, consistent with the present invention, for determining the position of a mobile terminal camped on a packet control channel;

FIG. 5 illustrates an exemplary communication session consistent with the present invention;

FIGS. 6A and 6B illustrate an exemplary process, consistent with the present invention, by which a mobile terminal responds to a SAMPS positioning request while camped on a packet control channel; and

FIGS. 7A-7C illustrate another exemplary communication session consistent with the present invention.

### DETAILED DESCRIPTION OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

Systems and methods, consistent with the present invention, determine the position of mobile terminals that are camped on packet control channels, such EGPRS-136 control channels. While the foregoing description provides for operation of a mobile terminal in an EGPRS-136 environment, it will be appreciated that the techniques described herein are equally applicable to other wireless communication environments.

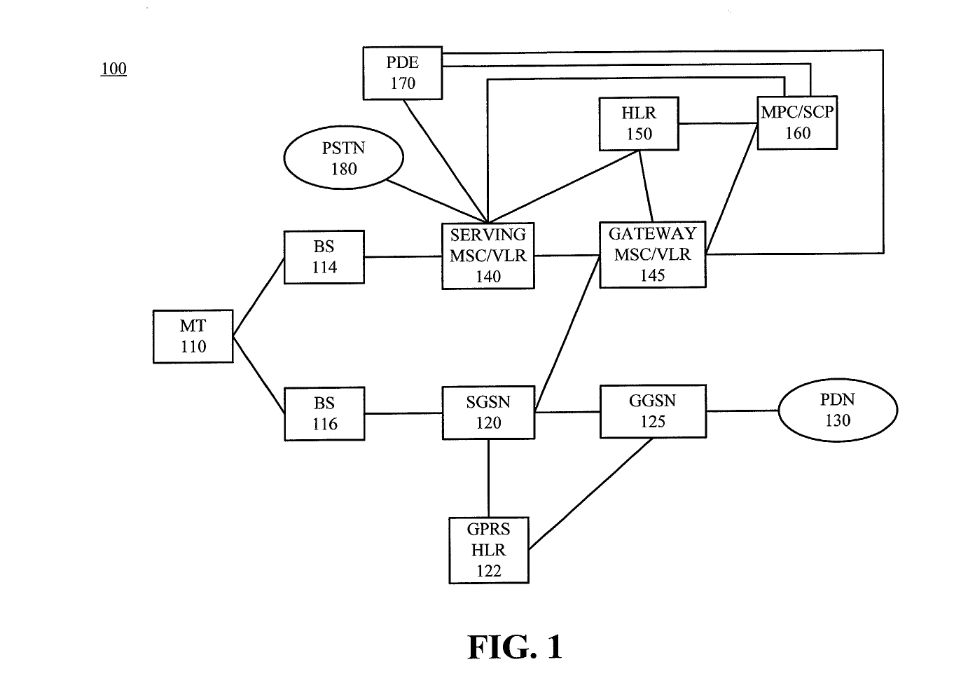

FIG. 1 illustrates an exemplary network 100 in which systems and methods, consistent with the present invention, may be implemented. The network 100 may include a mobile terminal (MT) 110, a group of base stations (BS) 114 and 116, a Serving General Packet Radio Service (GPRS) Serving Node (SGSN) 120, a GPRS Home Location Register (HLR) 122, a Gateway GPRS Serving Node (GGSN) 125, a Public Data Network (PDN) 130, a serving MSC/ VLR 140, a gateway MSC/VLR 145, a HLR 150, a Mobile Position Center (MPC)/Signal Control Point (SCP) 160, a Position Determining Entity (PDE) 170, and a Public Switched Telephone Network (PSTN) 180. The number of components illustrated in FIG. 1 is provided for simplicity. It will be appreciated that a typical network 100 may include more or less components than are illustrated in FIG. 1.

The mobile terminal 110 allows a user to interact with other devices via PDN 130 or PSTN 180. It is assumed hereafter that the mobile terminal 110 communicates using EGPRS-136 to send and receive data via the PDN 130 and Time Division Multiple Access (TDMA) to make and receive calls through the PSTN 180. As described herein, the mobile terminal 110 may include a radiotelephone with or without a multi-line display; a Personal Communications System (PCS) terminal that may combine a cellular radiotelephone with data processing, facsimile, and data communications capabilities; a Personal Digital Assistant (PDA) that can include a radiotelephone, pager, Internet/intranet access, Web browser, organizer, and/or calendar; and a conventional laptop and/or palmtop receiver or other appliance that includes a radiotelephone transceiver. Mobile terminals may also be referred to as “pervasive computing”devices.

The base stations 114 and 116 allow other devices to communicate with mobile terminal 110. Base station 114 may provide the mobile terminal 110 with circuit-switched services on, for example, a 30 kHz air interface. Base station 116 may provide the mobile terminal 110 with packet data services on, for example, a 200 kHz air interface. Each base station 114 and 116 may include one or more base transceiver stations (not shown) and a base station controller (not shown). The base transceiver stations may transmit radio signals to and receive radio signals from the mobile terminal 110. The base station controller may interconnect a number of base transceiver stations to the SGSN 120 or serving MSC/VLR 140.

The SGSN 120 may include circuitry for controlling packet data sessions between the mobile terminal 110 and other devices. The SGSN 120 may connect those sessions to the GGSN 125. The GPRS HLR 122 may include one or more databases that store and manage subscriber data for a subscriber's packet data services. Upon interrogation by the SGSN 120, the GPRS HLR 122 may provide packet data subscription-related information. Upon interrogation by the GGSN 125, the GPRS HLR 122 may provide routing information for the indicated subscriber.

The GGSN 125 may include circuitry for connecting packet data sessions between the mobile terminal 110 and the PDN 130. The PDN 130 may include one or more conventional networks for routing data packets.

The serving MSC/VLR 140 may include circuitry for controlling circuit calls to/from the mobile terminal 110 and other devices and connects those calls to the PSTN 180. The gateway MSC/VLR 145 may control circuit-related signaling to/from the mobile terminal 110 during those periods when the mobile terminal 110 is camped on a packet channel. The gateway MSC/VLR 145 tunnels this signaling to the mobile terminal 110 in a well-known manner through the SGSN 120. Tunneling involves, for example, the use of circuit-switched protocols on a packet control channel.

Similar to the GPRS HLR 122, the HLR 150 may include one or more databases that store and manage subscriber data for a subscriber's circuit-switched services. Upon interrogation by the serving MSC/VLR 140, the HLR 150 provides routing information for the indicated subscriber.

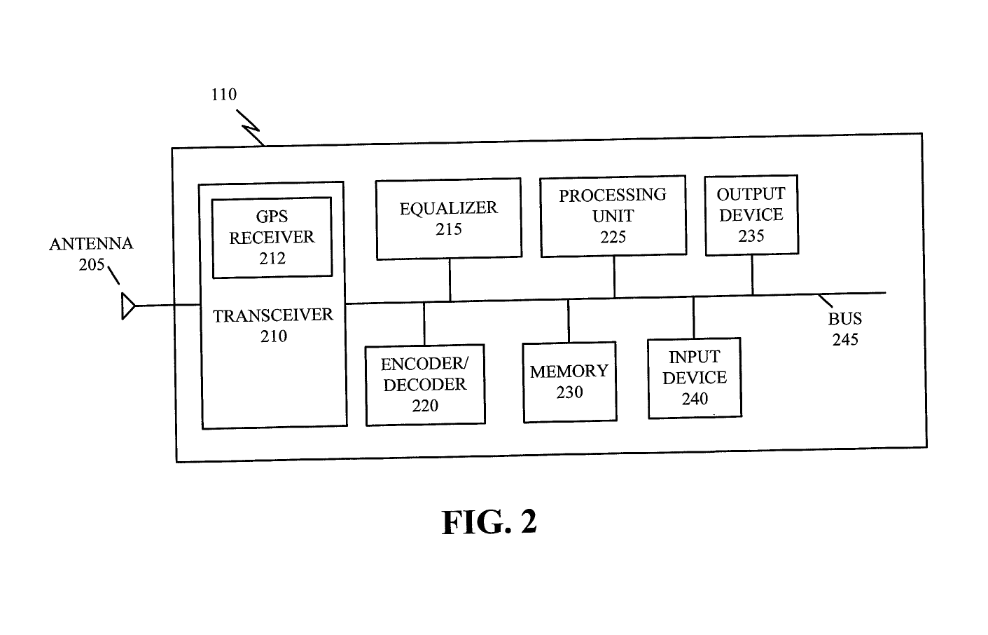

The MPC/SCP 160 may include circuitry for providing information regarding a mobile terminal's 110 position in response to positioning requests. The PDE 170 includes circuitry for determining a mobile terminal's 110 position and/or helps a mobile terminal 110 determine its own position. The PSTN 180 may include the worldwide telephone network, consisting of wires and switches, that allows for connection of telephone calls. FIG. 2 illustrates an exemplary configuration of mobile terminal 110 consistent with the present invention. As illustrated, the mobile terminal 110 may include an antenna 205, a transceiver 210, an equalizer 215, an encoder/decoder 220, a processing unit 225, a memory 230, an output device 235, an input device 240, and a bus 245.

The antenna 205 may include one or more conventional antennas capable of transmitting and receiving information. The transceiver 210 may include well-known transceiver circuitry for transmitting and/or receiving data bursts in a network, such as network 100, via the antenna 205. The transceiver 210 may also include a GPS receiver 212 that aids the mobile terminal 110 in determining its position within the network 100.

The equalizer 215 may include one or more conventional equalizers, such as a Viterbi equalizer, for removing intersymbol interference. The encoder/decoder 220 may include conventional circuitry for encoding and/or decoding received or transmitted symbol sequences.

The processing unit 225 may include any type of conventional processor or microprocessor that interprets and executes instructions. The processing unit 225 may perform all data processing functions for inputting, outputting, and processing of data. The memory 230 may provide permanent, semi-permanent, or temporary working storage of data and instructions for use by processing unit 225 in performing processing functions. Memory 230 may include large-capacity storage devices, such as a magnetic and/or optical recording medium and its corresponding drive.

The output device 235 may include one or more conventional mechanisms that output information to an operator, including a display, a printer, a speaker, etc. The input device 240 may include one or more conventional mechanisms that permit the operator to input information to the mobile terminal 110, such as a keypad, a mouse, a microphone, a pen, voice recognition and/or biometric mechanisms, etc. The output and input devices 235 and 240 may include additional devices (not shown) for converting received information from a first format into a second format.

The bus 245 may include one or more conventional buses that interconnect the various components of mobile terminal 110 to permit the components to communicate with one another.

The configuration of mobile terminal 110, shown in FIG. 2, is for provided for illustrative purposes only. One skilled in the art will recognize that other configurations may be employed. Moreover, one skilled in the art will appreciate that a typical mobile terminal 110 may include other devices that aid in the reception, transmission, or processing of data.

Typically, when the mobile terminal 110 is first powered up, it searches for control channels (e.g., DCCHs) on which to camp. After the mobile terminal 110 finds a satisfactory DCCH, the mobile terminal 110 may look for pointers to the EGPRS-136 control channels. If a pointer is found, the mobile terminal 110 may follow this pointer to an EGPRS-136 control channel.

When the mobile terminal 110 finds the EGPRS-136 control channel, it first attaches for packet data services and then tunnels a registration to the gateway MSC/VLR 145 via the SGSN 120 (i.e., the mobile terminal 110 transmits the registration to the circuit-switched part of network 100 while being attached for packet data services). This allows the MSC/VLR 145 to know how to reach the mobile terminal 110 in the event the mobile terminal 110 receives a page. At this point, the mobile terminal 110 is considered successfully camping on the EGPRS-136 packet control channel.

The mobile terminal 110 may perform the above processing and the processing described below in response to the processing unit 225 executing sequences of instructions contained in a computer-readable medium, such as memory 230. It should be understood that a computer-readable medium may include one or more memory devices and/or carrier waves. The instructions may be read into memory 230 from another computer-readable medium or from a separate device via transceiver 210. Execution of the sequences of instructions contained in memory 230 causes processing unit 225 to perform the acts that will be described hereafter. In alternative embodiments, hard-wired circuitry may be used in place of or in combination with software instructions to implement the present invention. Thus, the present invention is not limited to any specific combination of hardware circuitry and software.

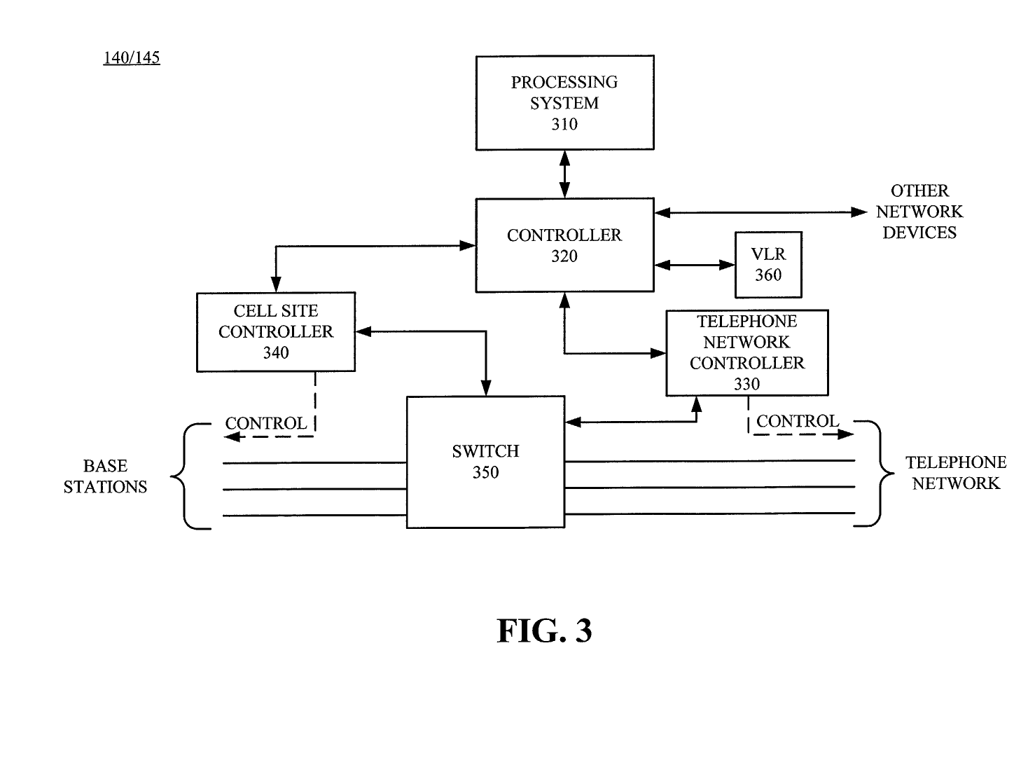

FIG. 3 illustrates an exemplary configuration of a gateway/serving (G/S) MSC/VLR 140/145 consistent with the present invention. As illustrated, the G/S MSC/VLR 140/145 may include a processing system 310, a controller 320, a telephone network controller 330, a cell site controller 340, a switch 350, and a VLR 360.

The processing system 310 may include one or more computer devices, such as personal computers, servers, laptops, personal digital assistants, etc. The controller 320 may include any type of conventional processor or microprocessor (not shown) that interprets and executes instructions. The controller 320 may also include one or more memory devices (not shown). The processing system 310 and controller 320 control the overall operations of the G/S MSC/VLR 140/145.

The telephone network controller 330 may include one or more processors or microprocessors, and associated memory devices, for controlling connections to a telephone network, such as PSTN 180. The telephone network controller 330 may, in an implementation consistent with the present invention, include a Signaling System 7 controller. Similar to the telephone network controller 330, the cell site controller 340 may include one or more processors or microprocessors, and associated memory devices, for controlling connections to the base stations served by the G/S MSC/VLR 140/145, such as base station 114.

The switch 350 may include one or more physical or electronic switches. The switch 350 may serve to connect the base stations served by the G/S MSC/VLR 140/145 to the telephone network. The VLR 360 may include one or more databases, located at the G/S MSC/VLR 140/145 or remotely therefrom. The VLR 360 may store information about visiting subscribers and local (i.e., home) subscribers that are currently authorized to use the network 100.

The configuration of G/S MSC/VLR 140/145, shown in FIG. 3, is provided for illustrative purposes only. One skilled in the art will recognize that other configurations may be employed. For example, the serving MSC/VLR 140 and gateway MSC/VLR 145 may be implemented as a single device, as illustrated in FIG. 3, or as two separate devices, as illustrated in FIG. 1. Moreover, one skilled in the art will appreciate that a typical G/S MSC/VLR 140/145 may include other devices (not shown) that aid in the reception, transmission, or processing of data.

The G/S MSC/VLR 140/145 may perform the processing described below in response to the processing system 310 executing sequences of instructions contained in a computer-readable medium. As described above, a computer-readable medium may include one or more memory devices and/or carrier waves. Execution of the sequences of instructions contained in the computer-readable medium causes processing system 310 to perform the acts that will be described hereafter. In alternative embodiments, hard-wired circuitry may be used in place of or in combination with software instructions to implement the present invention. Thus, the present invention is not limited to any specific combination of hardware circuitry and software.

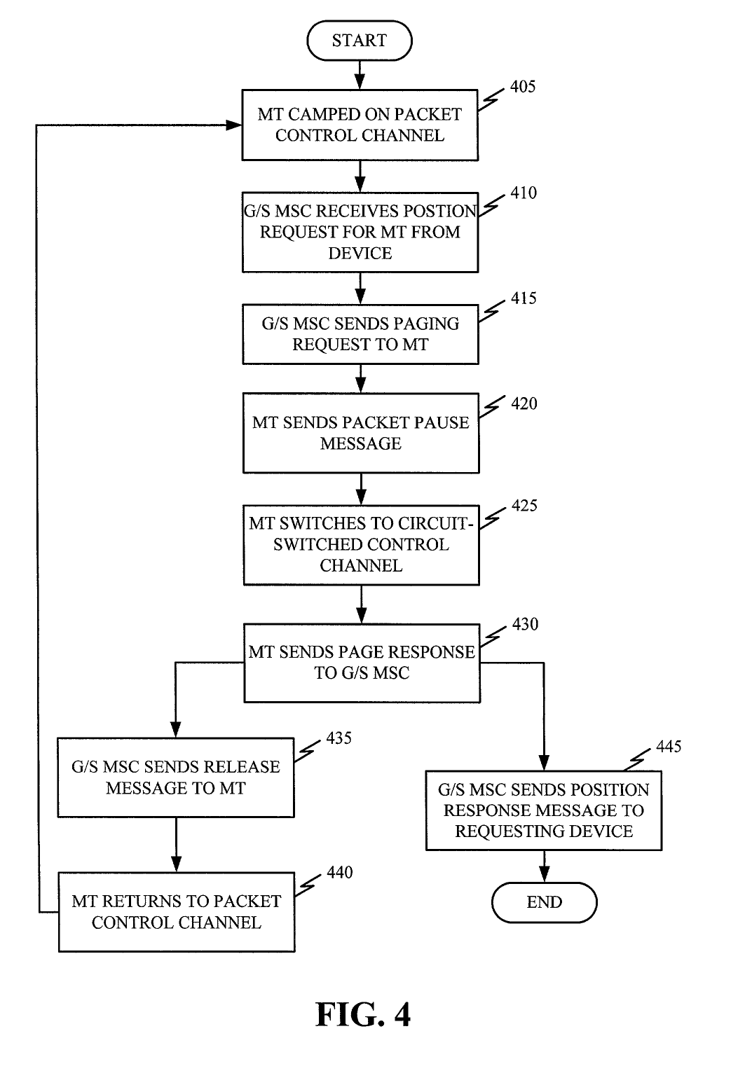

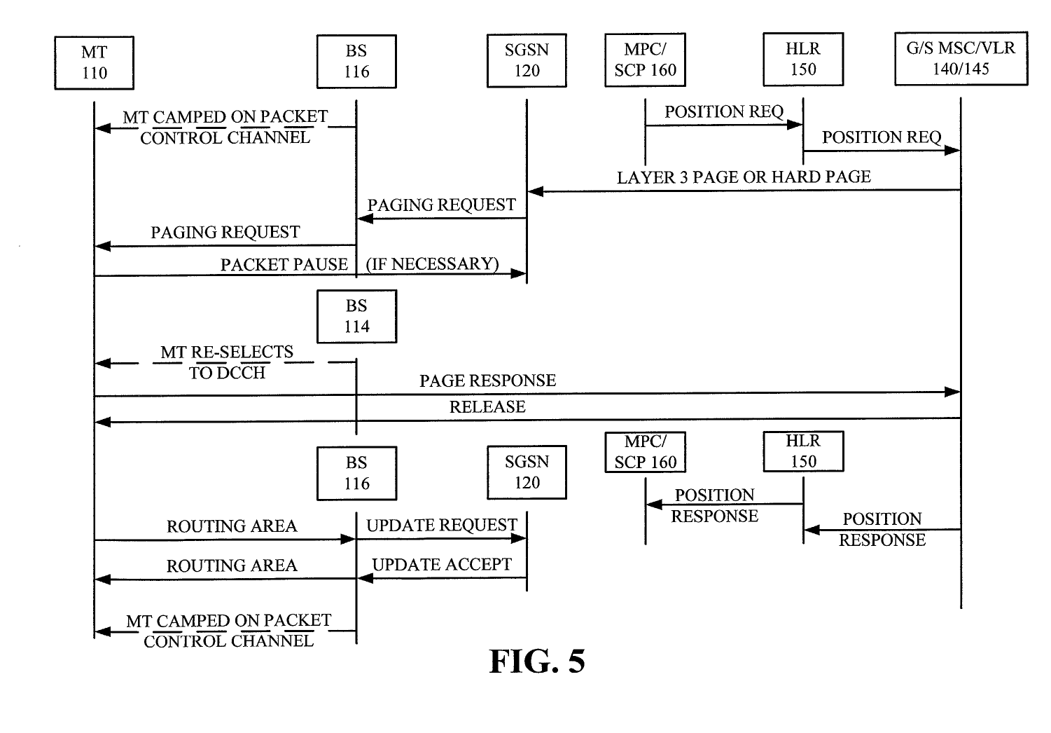

FIG. 4 illustrates an exemplary process, consistent with the present invention, for determining the position of a mobile terminal, such as mobile terminal 110, camped on a packet control channel. It is assumed herein that the packet control channel is an EGPRS-136 packet control channel. The process illustrated in FIG. 4 will be described in conjunction with the exemplary communication session illustrated in FIG. 5.

Processing begins with the mobile terminal 110 camped on the packet control channel [act 405]. During the time that the mobile terminal 110 is camped on the packet control channel, the G/S MSC/VLR 140/145 may receive a position request for the mobile terminal 110 from a network device, such as MPC/SCP 160 or PDE 170 [act 410]. The network device may transmit the position request to the G/S MSC/VLR 140/145 in an attempt to locate or track the mobile terminal 110. As illustrated in FIG. 5, the network device may transmit the position request to the G/S MSC/VLR 140/145 via the HLR 150.

In response to receiving the position request, the G/S MSC/VLR 140/145 may transmit a paging request to the mobile terminal 110 [act 415]. As illustrated in FIG. 5, the G/S MSC/VLR 140/145 may transmit a layer 3 paging message or hard paging message to the SGSN 120 that is serving the mobile terminal 110. It will be appreciated that a hard page has a default service associated with it that requires the mobile terminal 110 to send a page response. Similarly, the layer 3 page may indicate a type of service (e.g., a circuit-switched service) that would require the mobile terminal 110 to transmit a page response. For example, the layer 3 paging message may include a Wide Open R-Data Transport (WORT) indication or a teleservice indication. In response to the hard page or layer 3 page, the SGSN 120 may transmit a paging request to the base station 116, which forwards the paging request to the mobile terminal 110 via the packet control channel.

When the mobile terminal 110 receives either the hard page or the layer 3 page indicating a circuit-switched service, the mobile terminal 110 may suspend packet data services by, for example, transmitting a packet pause request to the SGSN 120 [act 420]. The mobile terminal 110 may then attempt to camp on an associated circuit-switched control channel [act 425]. It is assumed herein that the circuit-switched control channel is a digital control channel (DCCH). Once on the DCCH, the mobile terminal 110 may respond to the paging request by transmitting a page response to the G/S MSC/VLR 140/145 [act 430].

Upon receiving the page response, the G/S MSC/VLR 140/145 may send a release message to the mobile terminal 110 [act 435]. The mobile terminal 110 may then return to the packet control channel where it may perform a routing area update procedure in order to resume packet data services [act 440].

The G/S MSC/VLR 140/145 may determine the location of the mobile terminal 110 based on the mobile terminal's 110 page response. For example, the G/S MSC/VLR 140/145 may determine, from the page response, in which cell or cell sector the mobile terminal 110 is located. The G/S MSC/VLR 140/145 may then transmit a position response message to the requesting device [act 445]. As illustrated in FIG. 5, the G/S MSC/VLR 140/145 may transmit the position response message to the requesting device via the HLR 150.

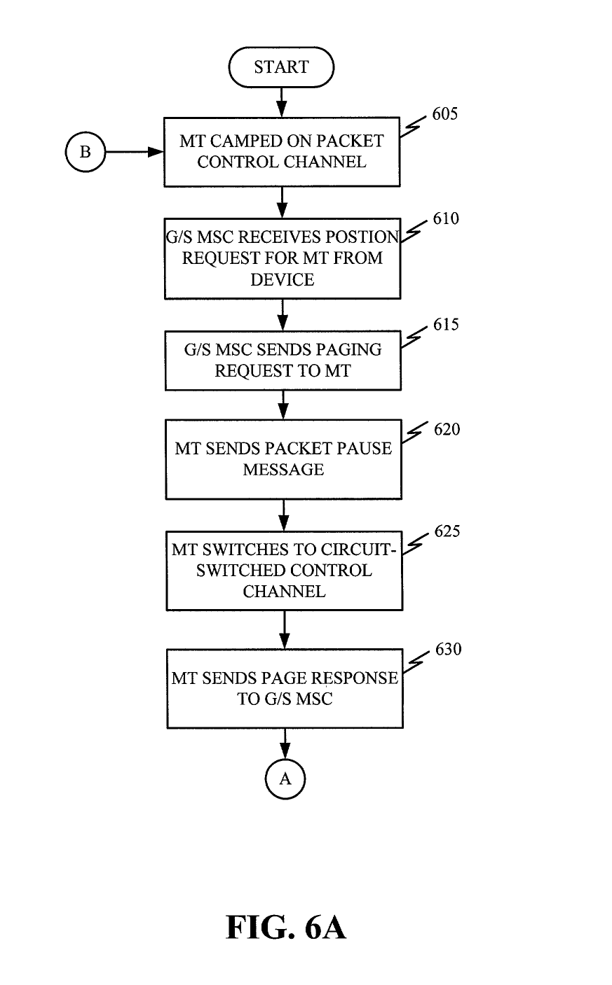

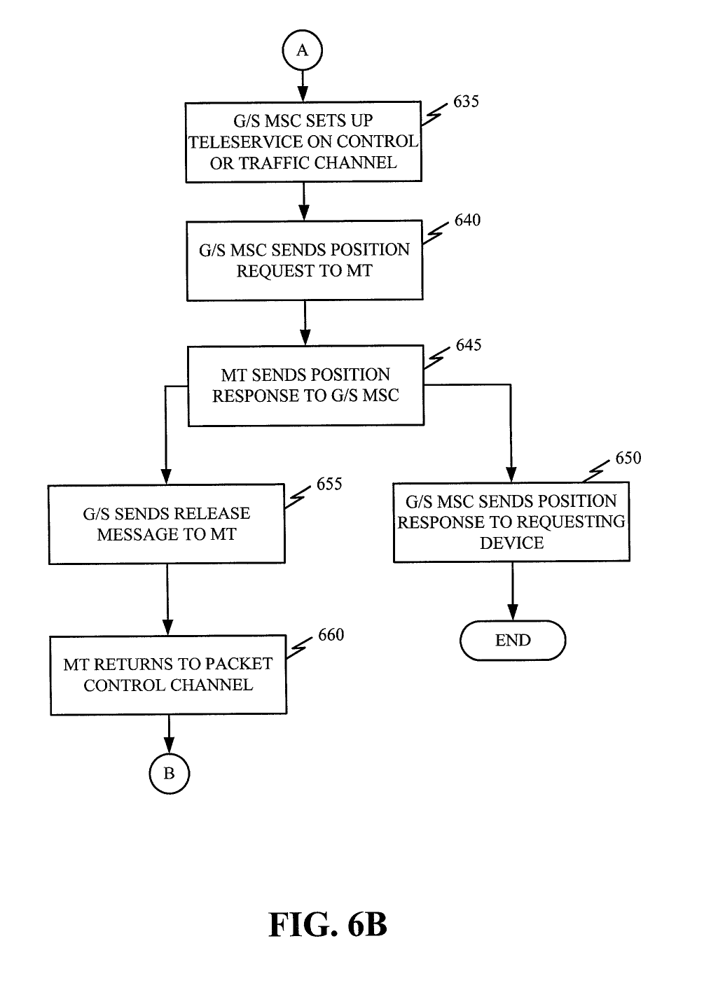

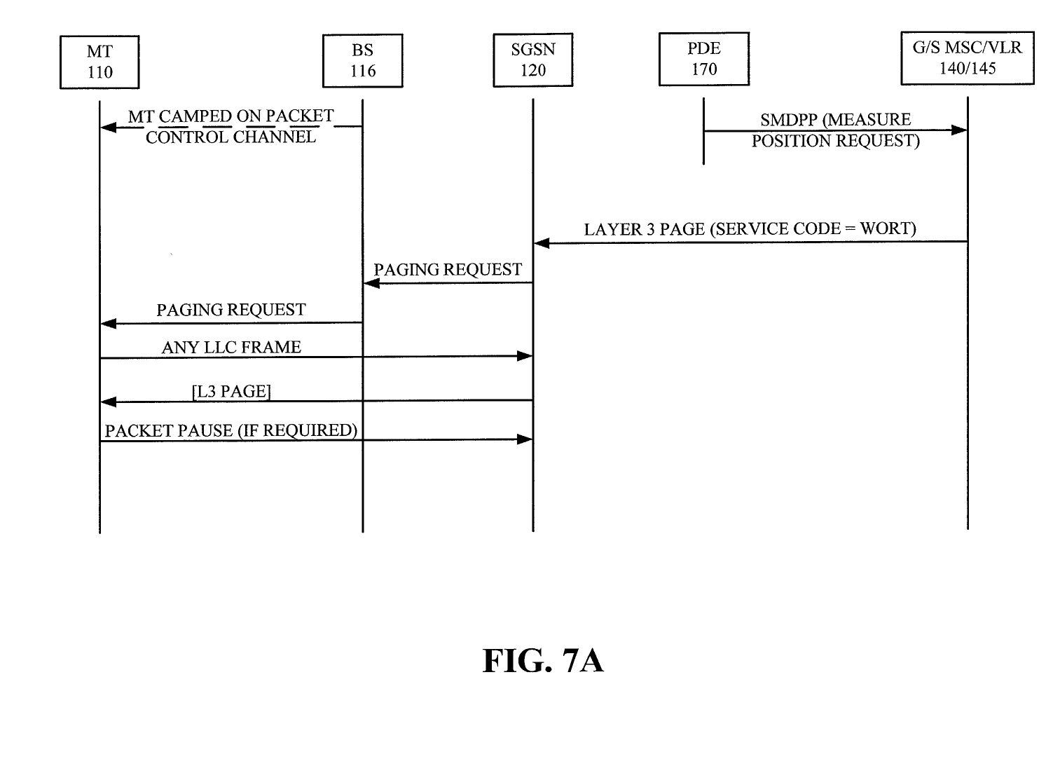

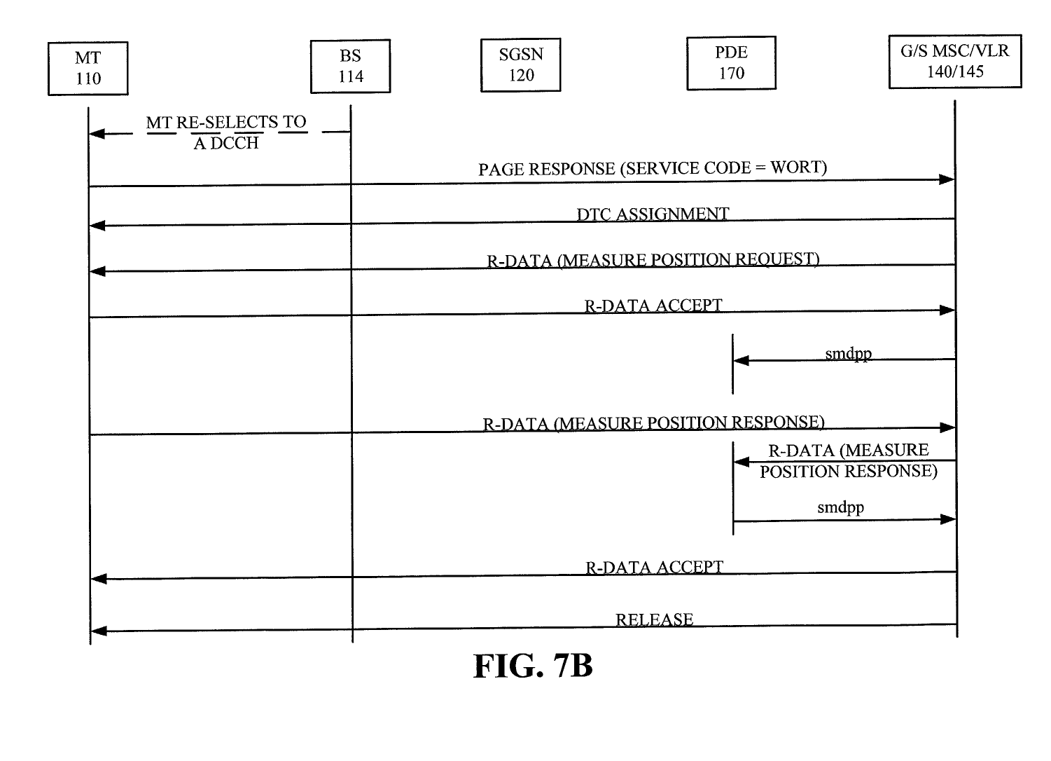

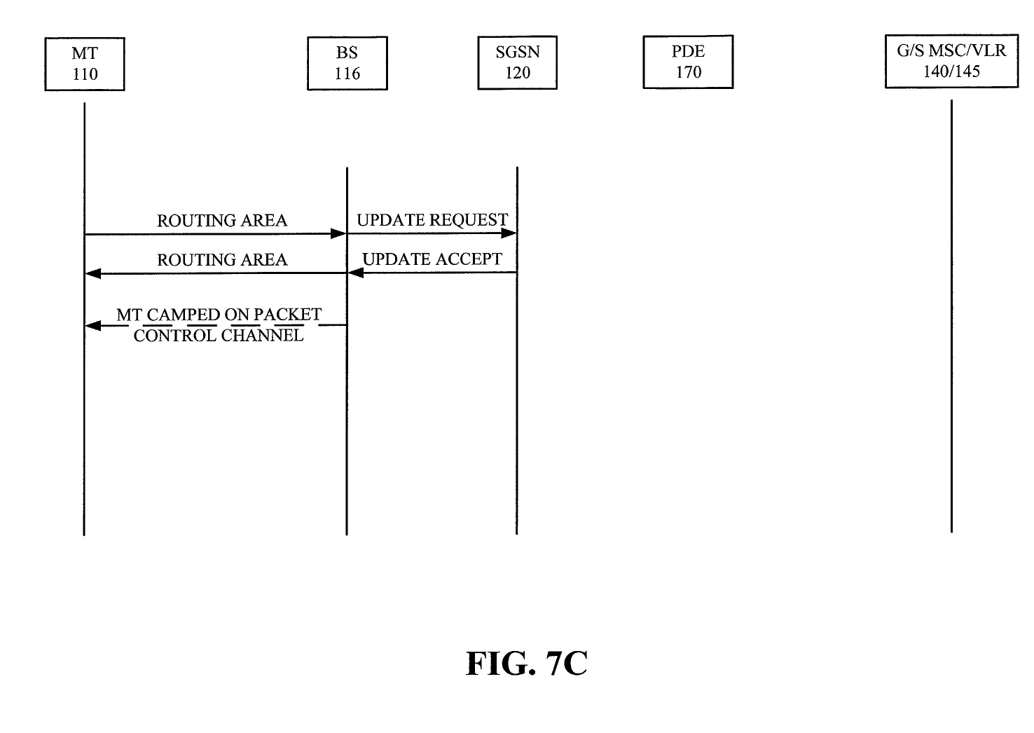

FIGS. 6A and 6B illustrate an exemplary process, consistent with the present invention, by which a mobile terminal, such as mobile terminal 110, responds to a SAMPS positioning request while camped on a packet control channel, such as an EGPRS-136 packet control channel. The process illustrated in FIGS. 6A and 6B will be described in conjunction with the exemplary communication session illustrated in FIGS. 7A-7C.

Processing may begin with the mobile terminal camped on the packet control channel [act 605]. During the time that the mobile terminal 110 is camped on the packet control channel, the G/S MSC/VLR 140/145 may receive a positioning request for the mobile terminal 110 [act 610]. The position request message may, for example, originate from PDE 170. In an implementation consistent with the present invention, the G/S MSC/VLR 140/145 may receive the positioning request as part of a Short Message Delivery Point-to-Point (SMDPP) message.

In response to receiving the positioning request, the G/S MSC/VLR 140/145 may send a layer 3 page to the mobile terminal that indicates a circuit-switched service (e.g., a teleservice or WORT) [act 615]. It is assumed hereafter that the G/S MSC/VLR 140/145 transmits a layer 3 page that includes a WORT indication. It will be appreciated that a WORT indication specifies that a digital traffic channel (DTC) is to be set up to transport R-Data messages (i.e., control signals).

As illustrated in FIG. 7A, the G/S MSC/VLR 140/145 may transmit the layer 3 page to the SGSN 120. The SGSN 120 may then transmit a paging request to the mobile terminal 110 via the base station 116. Upon receiving the paging request, the mobile terminal 110 may respond by transmitting an empty link layer control (LLC) frame to the SGSN 120. The SGSN 120 may then transmit the layer 3 page from the G/S MSC/VLR 140/145 to the mobile terminal 110.

In response to receiving the layer 3 page containing the WORT indication, the mobile terminal 110 may suspend packet data services by, for example, transmitting a packet pause request to the SGSN 120 [act 620]. The mobile terminal 110 may then attempt to camp on an associated circuit-switched control channel [act 625] (FIG. 7B). It will be assumed herein that the mobile terminal 110 switches to a DCCH.

Once on the DCCH, the mobile terminal 110 may transmit a page response message to the G/S MSC/VLR 140/145 [act 630]. The page response may include a WORT indication. The G/S MSC/VLR 140/145 may then set up a teleservice session either on a DCCH (for a teleservice page) or a DTC (for a WORT page) [act 635] (FIG. 6B). The G/S MSC/VLR 140/145 may transmit a measure position request on the assigned channel [act 640].

In response to receiving the measure position request, the mobile terminal 110 may acknowledge the request via, for example, an R-Data Accept message which the G/S MSC/VLR 140/145 may forward to the requesting device in the form of a smdpp message (FIG. 7B). The mobile terminal 110 may also transmit a measure position response to the G/S MSC/VLR 140/145 [act 645]. The measure position response may include the actual position of the mobile terminal 110 or measurements made by the mobile terminal 110 by which the requesting device may determine the mobile terminal's 110 position. The G/S MSC/VLR 140/145 may determine the location of the mobile terminal 110 based on the mobile terminal's 110 measure position response. For example, the G/S MSC/VLR 140/145 may determine, from the page response, in which cell or cell sector the mobile terminal 110 is located. The G/S MSC/VLR 140/145 may then transmit a measure position response message to the requesting device [act 650].

Upon receiving the page response, the G/S MSC/VLR 140/145 may acknowledge the receipt of the measure position response via, for example, an R-Data Accept message (FIG. 7B). The G/S MSC/VLR 140/145 may also send a release message to the mobile terminal 110 [act 655]. The mobile terminal 110 may then return to the packet control channel where it may perform a routing area update procedure in order to resume packet data services [act 660] (FIG. 7C).

The foregoing description of preferred embodiments of the present invention provides illustration and description, but is not intended to be exhaustive or to limit the invention to the precise form disclosed. Modifications and variations are possible in light of the above teachings or may be acquired from practice of the invention. For example, the described implementation includes software and hardware, but elements of the present invention may be implemented as a combination of hardware and software, in software alone, or in hardware alone. Additionally, the present invention has been described in the context of a G/S MSC/VLR. The present invention, however, may be implemented in other devices or systems in a communication network. Also, while series of acts have been described with regard to FIGS. 4, 6A, and 6B, the order of the acts may be varied in other implementations consistent with the present invention. No element, act, or instruction used in the description of the present application should be construed as critical or essential to the invention unless explicitly described as such.

The present invention may be embodied as cellular communication systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may include any medium that can contain, store, communicate, propagate, or transport the program for use by, or in connection with, the instruction execution system, apparatus, or device. The computer-usable or computer-readable medium may include, for example, but not limited to, an electronic, magnetic, optical, electromagnetic, infrared, or semiconductor system, apparatus, device, or propagation medium.

More specific examples (a non-exhaustive list) of a computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Additionally, the present invention is described herein in the context of an EGPRS-136 cellular communications system. While the present invention may be particularly useful for improving the performance of EGPRS-136 cellular networks, it should be understood that the principles of the present invention may be applied to any cellular or wireless system utilizing other air interfaces. It should be further understood that the principles of the present invention may be utilized in hybrid systems that are combinations of two or more conventional air interfaces. In addition, a mobile terminal, in accordance with the present invention, may be designed to communicate with a base station transceiver using any standard based on GSM, TDMA, CDMA, FDMA, a hybrid of such standards or any other standard.

The scope of the invention is defined by the claims and their equivalents.

What is claimed is:

1. A method for determining a position of a mobile terminal tuned to a first control channel, comprising:
transmitting a paging request to the mobile terminal via the first control channel;
switching from the first control channel to a second control channel;
transmitting a paging response via the second control channel; and
determining the position of the mobile terminal based on the paging response.

2. The method of claim 1 wherein the first control channel is a packet control channel and the second control channel is a circuit-switched control channel.

3. The method of claim 2 wherein the first control channel is an Enhanced General Packet Radio Service 136 (EGPRS-136) control channel and the second control channel is a digital control channel.

4. The method of claim 1 further comprising:
transmitting, in response to the paging response, a release message via the second control channel;
receiving the release message; and
switching from the second control channel to the first control channel in response to the release message.

5. The method of claim 1 wherein the paging request is one of a hard page and a layer 3 page comprising a teleservice indication or Wide Open R-Data Transport indication.

6. The method of claim 1 wherein the determining the position of the mobile terminal based on the paging response comprises:
determining a cell in which the mobile terminal is positioned.

7. A system for determining a position of a mobile terminal tuned to a first control channel in a wireless communication network, comprising:
a memory that stores instructions; and
a processor that executes the instructions to send a paging request to the mobile terminal via the first control channel, the paging request indicating that the mobile terminal is to switch to a second control channel, receive a paging response from the mobile terminal via the second control channel, and determine the position of the mobile terminal based on the paging response.

8. The system of claim 7 wherein the first control channel is a packet control channel and the second control channel is a circuit-switched control channel.

9. The system of claim 7 wherein the paging request is one of a hard page and a layer 3 page indicting a circuit-switched service.

10. The system of claim 7 wherein, after receiving a paging response from the mobile terminal via the second control channel, the processor sends a release message to the mobile terminal, the release message indicating that the mobile terminal may switch back to the first control channel.

11. The system of claim 7 wherein, when determining the position of the mobile terminal based on the paging response, the processor determines a cell sector in which the mobile terminal is located.

12. A computer-readable medium containing instructions for controlling at least one processor to perform a method for determining a position of a mobile terminal tuned to a first control channel, the method comprising:
sending a paging request to the mobile terminal via the first control channel, the paging request indicating that the mobile terminal is to switch to a second control channel;
receiving a paging response from the mobile terminal via the second control channel; and
determining the position of the mobile terminal based on the paging response.

13. The computer-readable medium of claim 12 wherein the first control channel is a packet control channel and the second control channel is a circuit-switched control channel.

14. The computer-readable medium of claim 12 wherein the paging request is one of a hard page and a layer 3 page comprising a teleservice indication or Wide Open R-Data Transport indication.

15. The computer-readable medium of claim 12 wherein the method further comprises:
sending, after receiving a paging response from the mobile terminal via the second control channel, a release message to the mobile terminal, the release message indicating that the mobile terminal may switch back to the first control channel.

16. A method for determining a position of a mobile terminal tuned to a first control channel, comprising:
transmitting a paging request to the mobile terminal via the first control channel;
switching from the first control channel to a second control channel;
receiving a paging response via the second control channel from the mobile terminal;
transmitting a position request to the mobile terminal;
receiving a position response from the mobile terminal; and
determining the position of the mobile terminal based on the position response.

17. The method of claim 16 wherein the first control channel is a packet control channel and the second control channel is a circuit-switched control channel.

18. The method of claim 16 wherein the paging request is a layer 3 page comprising a teleservice indication or a Wide Open R-Data Transport indication.

19. The method of claim 16 further comprising:
assigning, in response to receiving the paging response, one of a control channel and a traffic channel, and
wherein the transmitting a position request to the mobile terminal occurs via the assigned channel.

20. The method of claim 16 further comprising:
transmitting a release message after receiving the position response.

21. The method of claim 16 wherein the determining the position of the mobile terminal based on the position response comprises:
determining a cell sector in which the mobile terminal is located.

22. A system for determining a position of a mobile terminal tuned to a first control channel in a wireless communication network, comprising:
a memory that stores instructions; and
a processor that executes the instructions to send a paging request to the mobile terminal via the first control channel, the paging request indicating that the mobile terminal is to switch to a second control channel, receive a paging response from the mobile terminal via the second control channel, transmit a position request to the mobile terminal, receive a position response, and determine the position of the mobile terminal based on the position response.

23. The system of claim 22 wherein the first control channel is a packet control channel and the second control channel is a circuit-switched control channel.

24. The system of claim 22 wherein the paging request is a layer 3 page indicating a circuit-switched service.

25. The system of claim 22 wherein, in response to receiving the paging response, the processor assigns one of a control channel and a traffic channel, and
wherein, when transmitting a position request to the mobile terminal, the processor transmits the position response via the assigned channel.

26. The system of claim 22 wherein, when determining the position of the mobile terminal based on the position response, the processor determines a cell in which the mobile terminal is located.

27. A computer-readable medium containing instructions for controlling at least one processor to perform a method for determining a position of a mobile terminal tuned to a first control channel, the method comprising:
transmitting a paging request to the mobile terminal via the first control channel;
receiving a response to the paging request via a second control channel;
transmitting a position request to the mobile terminal;
receiving a position response; and
determining the position of the mobile terminal based on the position response.

28. The computer-readable medium of claim 27 wherein the first control channel is a packet control channel and the second control channel is a circuit-switched control channel.

29. The computer-readable medium of claim 27 wherein the paging request is a layer 3 page comprising a teleservice indication or Wide Open R-Data Transport indication.

30. The computer-readable medium of claim 27 wherein the method further comprises:
assigning, in response to receiving the paging response, one of a control channel and a traffic channel, and
wherein the transmitting a position request to the mobile terminal occurs via the assigned channel.

31. The computer-readable medium of claim 27 wherein the determining the position of the mobile terminal based on the position response comprises:
determining a cell sector in which the mobile terminal is located.
